(19) United States
(12) Patent Application Publication
(10) Pub. No.: US 2013/0336697 A1
(43) Pub. Date: Dec. 19, 2013

(54) PRINTING ON ALTERNATIVE PRINT MEDIA WHEN PREFERRED MEDIA IS UNAVAILABLE

(71) Applicants: Trevor J. Snyder, Newberg, OR (US); Jignesh P. Sheth, Webster, NY (US); Paul V. Gasse, Tigard, OR (US); Daniel C. Park, Woodinville, WA (US)

(72) Inventors: Trevor J. Snyder, Newberg, OR (US); Jignesh P. Sheth, Webster, NY (US); Paul V. Gasse, Tigard, OR (US); Daniel C. Park, Woodinville, WA (US)

(73) Assignee: Xerox Corporation, Norwalk, CT (US)

(21) Appl. No.: 13/525,632

(22) Filed: Jun. 18, 2012

(51) Int. Cl. B41J 11/44

(52) U.S. Cl. 400/76

(57) ABSTRACT

When an insufficient quantity of a preferred print media is installed in a selected printing device, methods and systems automatically output an insufficient-print-media notice and one or more reconfiguration options for proceeding with printing the print data on one of the installed print media types. In response, a selected reconfiguration option is received that identifies an alternative print media to be used in place of the preferred print media when executing the print request. Additional processing is performed to print the print data on the alternative print media including: automatically resizing the print data to fit on the alternative print media; automatically printing a cutline on the alternative print media to indicate where the alternative print media should be cut to be reduced to the preferred print media; and automatically formatting multiple pages of the print data to print on one page of the alternative print media.

### BACKGROUND

Embodiments herein generally relate to printing devices, printing systems, and associated methods and software, and more particularly to systems that provide messages to users when internal print media storage areas within printing devices become empty.

Home and office printers have been around for many years. The technology has matured significantly and the costs have continued to decrease while the functionality has increased. The printing market is very competitive and pressure continues to increase in all areas; print quality, printer cost, consumables cost, ease of use, reliability, service, etc. Therefore, there is value in finding new and novel approaches to meet the customer needs which create efficiencies and value. Customers needs include reliability, service, cost-per-page, ease-of-use, and new features. The printer is a tool for them to complete their job, and there is value in positive differentiation. The basic function of a printer has not changed much over the years. A printer provides a service to the customer by quickly and reliably placing structured marks on media. Many printers have multiple paper trays. This is especially true for office machines which typically have multiple trays for different size media (A4, legal, A3, etc. . . . ). However, currently when a printer runs out of the desired media, the printer stops running. There is value in efficient systems and methods which allow the printer to continue to print when one of the media trays is empty.

### SUMMARY

Some exemplary methods herein (which can be executed using non-transitory storage mediums storing instructions executable by computerized devices) receive a print request into a computerized device from a user. Again, the print request identifies a required quantity of preferred media and at least one selected printing device. The methods automatically determine quantities of one or more print media types currently installed in the selected printing device, using the computerized device.

When the quantities of the installed print media types indicate an insufficient quantity of the preferred print media is installed in the selected printing device, the methods automatically simultaneously output (from the computerized device to the user) an insufficient-print-media notice and one or more reconfiguration options for proceeding with printing the print data on one of the installed print media types. For example, the reconfiguration options can be displayed in a dialog containing the reconfiguration options, along with a graphic representation of the print appearance of each of the reconfiguration options.

In response, the user or technician can load the preferred print media, causing the computerized device to receive an indication from the selected printing device that the preferred print media has been installed into the selected printing device. Alternatively, rather than loading the preferred media, the user can select a reconfiguration option from the reconfiguration options presented. The selected reconfiguration option identifies the alternative print media from the installed print media types to be used in place of the preferred print media when executing the print request. The selected reconfiguration option also identifies additional processing to be performed by the computerized device.

The additional processing can include, for example, automatically resizing the print data to fit on the alternative print media, automatically printing a cutline on the alternative print media to indicate where the alternative print media should be cut to be reduced to the preferred print media, automatically formatting multiple pages of the print data to print on one page of the alternative print media. When resizing, the methods herein can increase (or decrease) the print size if the alternative print media is smaller (or larger) than the preferred print media. The cutline can be, for example, a dashed-line or a light line such as yellow, gray, etc.

When formatting multiple pages of the print data to print on one page of the alternative print media, the methods can perform duplex printing by changing the horizontal/vertical orientation of the pages of the print data, and positioning at least two of the pages of the print data on each side of the one page of the alternative print media.

In response to receiving the selected reconfiguration option, the computerized device performs the additional processing to print the print data on the alternative print media.

Exemplary system embodiments herein can use a computerized device that receives a print request from a user, and a printing device operatively connected to (directly or indirectly connected to) the computerized device. The print request includes print data, and identifies a required quantity of preferred media. The printing device automatically determines quantities of one or more installed print media types currently installed in the printing device. When the quantities of the installed print media types indicate an insufficient quantity of the preferred print media is installed in the selected printing device, the computerized device automatically simultaneously outputs to the user an insufficient-print-media notice and one or more reconfiguration options for proceeding with printing the print data on one of the installed print media types. The computerized device receives from the user a selected reconfiguration option from the reconfiguration options.

Again, the selected reconfiguration option identifies an alternative print media from the installed print media types to be used in place of the preferred print media when executing the print request. The selected reconfiguration option identifies additional processing to be performed by the computerized device. In response to receiving the selected reconfiguration option, the computerized device performs the additional processing to print the print data on the alternative print media.

Again, the additional processing can include, for example, automatically resizing the print data to fit on the alternative print media, automatically printing a cutline on the alternative print media to indicate where the alternative print media should be cut to be reduced to the preferred print media, automatically formatting multiple pages of the print data to print on one page of the alternative print media. These and other features are described in, or are apparent from, the following detailed description.

### BRIEF DESCRIPTION OF THE DRAWINGS

Various exemplary embodiments of the systems and methods are described in detail below, with reference to the attached drawing figures, in which:

FIG. 1 is a flow diagram illustrating embodiments herein;

FIG. 2 is a schematic diagram of a screenshot according to embodiments herein;

FIG. 3 is a schematic diagram of a screenshot according to embodiments herein;

FIG. 4 is a schematic diagram of a screenshot according to embodiments herein;

FIG. 5 is a schematic diagram of a screenshot according to embodiments herein;

FIG. 6 is a schematic diagram of a screenshot according to embodiments herein;

FIG. 7 is a schematic diagram of a screenshot according to embodiments herein;

FIG. 8 is a schematic diagram of a system according to embodiments herein;

FIG. 9 is a side-view schematic diagram of a device according to embodiments herein; and

FIG. 10 is a side-view schematic diagram of a device according to embodiments herein.

### DETAILED DESCRIPTION

As mentioned above, printing systems generally provide messages to users when internal print media storage trays within printing devices become empty, instructing the users to load more of the print media required by the print job, without any other options. In view of this, systems and methods herein keep the printer working even when it is out of preferred sizes of media. The systems and methods herein allow the customer to print on a secondary media when the primary media is out.

One feature of embodiments herein is that when the message that one or more print media trays is empty is displayed, the user is also presented with an option to print a smaller print job onto larger media when the smaller media is out. For example, systems and methods herein can provide an option to print two A4 pages on 11×17 along with the “print media empty” message. Alternatively, the systems and methods herein can provide an option to print an A4 page on legal with the “print media empty” message. When providing the option to print a smaller print job onto larger media, the systems and methods herein can also provide an option to automatically add a light dotted line (printed in yellow or gray, for example) on the media to show where the print needs to be cut to reduce the sheets down to the preferred smaller media size. For example, an A4 print job printed onto legal would be almost identical as that printed on the standard A4 sheet, except there would be a light line showing the cut point.

Similarly, the systems and methods herein can provide an option to print a larger sheet onto multiple smaller sheets when displaying the “print media empty” message. If such a feature is used, the systems and methods herein can provide an option to add a small yellow or gray numbering to such sheets to allow for the multiple smaller size sheets to be assembled when the print job is reconstructed. For example, when the customer prints out a large 11×17 image, but only has A4 or smaller media and receives a “print media empty” message, the systems and methods herein can provide an option to split the larger 11×17 print job onto multiple smaller A4 sheets, or provide an option to shrink the 11×17 image onto the A4 sheets.

Additionally, upon user instruction, the systems and methods herein can provide an option to automatically convert any duplex job onto different sized media when displaying the “print media empty” message. For example, when printing an A4 duplex print job onto 11×17, the systems and methods herein swizzle the first and second pages onto the correct parts of the two sides of the 11×17 sheet, thereby printing 2 corresponding pages on corresponding locations of each side of the 11×17 sheets.

The systems and methods herein provide the user such menu choices on the printing device's graphic user interface or a print scout can automatically present the user with such options when the user is setting up the print job, which allows the customer to make the selection at their desk before they go to the printer. Additionally, the option dialogs herein can offers visual diagrams of the options.

Further, systems and methods herein can provide buttons for reordering supplies when displaying the “print media empty” message. Such a “reorder supplies” button takes the customer directly to a point for reordering supplies. This can be a printer driver and computer based custom ordering system or a simple link to the appropriate web page for supplies, etc.

The features provided by the systems and methods herein work together as part of the out-of-media condition, so the printer is communicating with the customer to warn the customer of the out-of-media situation and to simultaneously provide the user with smart, friendly, and intuitive choices. This allows the printer to interact with the customer to print “smartly” on a secondary media when the primary media is out. With the systems and methods herein, the printer proactively offers the user options for printing during an out-of-media condition.

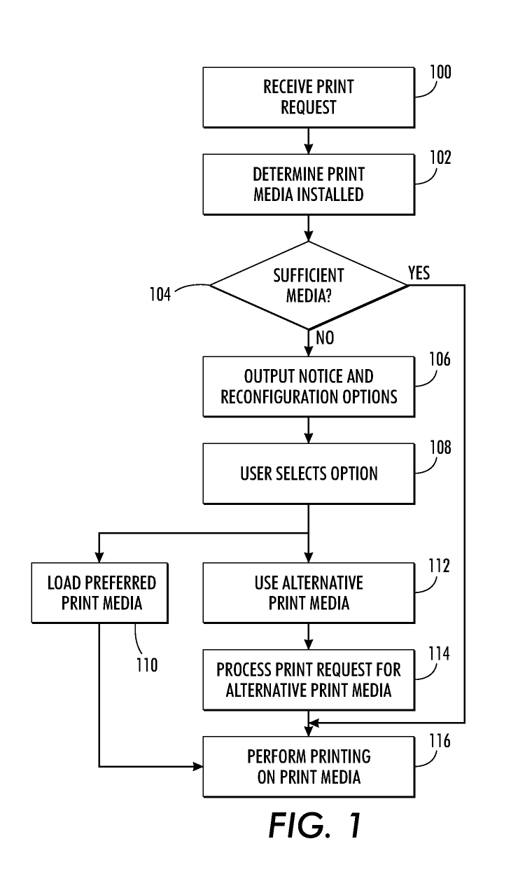

The foregoing is shown in flowchart form in FIG. 1. Thus, FIG. 1 illustrates exemplary methods (which can be executed using non-volatile (non-transitory) storage mediums storing instructions executable by computerized devices). The flow begins in item 100, where a print request is received into a computerized device from a user. The print request can be provided to a computerized printing device (such as a multi-function device (MFD)) by a user interacting with a graphic user interface (or hard buttons) on the printing device. Alternatively, the print request can be provided remotely, for example, through print driver operating on a computerized device (such as a user's personal computer (PC)) that is operatively connected to (directly or indirectly connected to) the printer through direct, wired connection or by way of a wired or wireless network (wide area network (WAN) or local area network (WAN)). The print request identifies a required quantity of preferred media and at least one selected printing device (e.g., A4 paper using Printer #3).

In item 102, the methods automatically determine quantities of the print media types that are currently installed in the selected printing device, using two-way communication print drivers operating within the computerized device. For example, the printing device has sensors in the paper trays, which automatically inform the printing device of the size and amount of print media currently within the paper trays. This print media size/quantity information is transferred to other computerized devices (potentially including other printing devices) over the network. Alternatively, item 102 can be a simple sensor that only indicates when a print media storage tray is empty.

In item 104, the methods herein determine which of the installed print types match that of the preferred print media, and check to see whether there is a sufficient amount of the preferred media installed in the selected printing device to complete the print request. For example, if the print request is for 100 sheets of A4 paper, and there are less than 100 sheets of A4 in the selected printing device, processing proceeds to item 106. If there are sufficient quantities of the preferred print media, printing proceeds to item 116, where the original print request is printed on the preferred print media in item 116. By checking for sufficient quantities before printing has begun, the systems and methods herein reduce the waste that can occur if a partial print job that could not be completed as requested is discarded. Alternatively, if item 102 only indicates when the preferred print media supply tray has become empty, item 104 can simply determine whether the preferred print media tray is empty or not.

When the quantities of the installed print media types (determined in item 102) indicate (in item 104) that an insufficient quantity of the preferred print media is installed in the selected printing device, in item 106 the methods automatically simultaneously output (from the computerized device to the user) an insufficient-print-media notice and one or more reconfiguration options for proceeding with printing the print data on one of the installed print media types. Thus, rather than just displaying an “out of paper” or similar message, the systems and methods herein simultaneously (e.g., at the same time, on the same screen) display one or more reconfiguration options along with the insufficient-print-media notice.

Therefore, with the methods and systems described herein, if the user is unable or unwilling to load the preferred print media, the user can still perform the printing operation with the print media currently installed in the printing device. Upon receiving an “out of paper” message, a user could manually cancel the original print request (potentially discarding the partially completed print job) and go back and set up a new print request for the media that they have now learned is currently installed in the printing device. However, this requires the walk-up user to manually reload the job and requires the remote user to return to their computer, and set up a new print request for the different, installed media. To the contrary, by simultaneously displaying the reconfiguration options 106 when the insufficient-print-media notice is displayed (as the print request is being made) this avoids requiring the user go back and reconfigure the print request. This increases user satisfaction, and reduces the waste that can occur if a partial print job that could not be completed as requested is discarded when the user sets up the new print request.

Further, even if such the option display 106 is provided after a portion of the print job is completed (if, for example, item 102 only indicates when the preferred print media supply tray has become completely empty) the user can still complete the remainder of the print job, without taking additional time to restart a different print job, and without substantial waste. In one example, upon user option selection, the remainder of the partially completed print request could be printed on larger print media (along with a cut line) allowing the user to cut the second portion of the print request printed on the larger print media. The two portions can then be recombined into a seamless output, with the only waste being the time/effort required to perform the cutting (which can be automated) and the wasted portion of the larger sheets cut off.

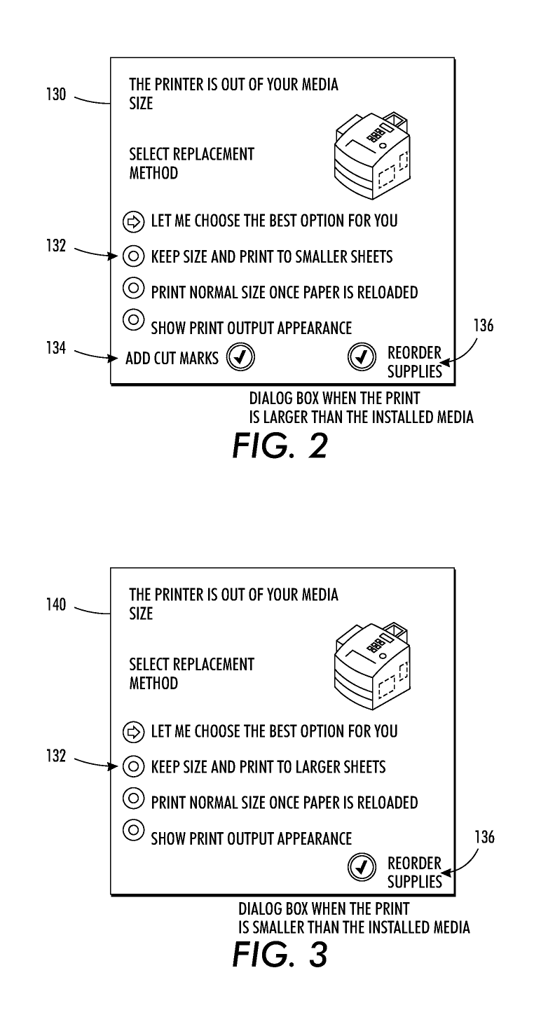

For example, as shown in FIGS. 2 and 3, the reconfiguration options can be displayed in a dialog containing the reconfiguration options. More specifically, FIGS. 2 and 3 are screen-shots of insufficient-print-media messages 130, 140 that includes various options 132 explaining to the user how the print request can be completed on the print media that is currently installed in the printing device. Such options 132 including letting the device automatically choose the best option, keeping the same size printing (but using multiple smaller sheets), printing on larger paper and adding cut lines, printing multiple pages on larger sheets, waiting for the preferred print media to be reloaded, etc., (as discussed above). In addition, the dialog 130 shown in FIG. 2 can provide an option 134 to add cutting marks. Both screenshots 130, 140 provide an option to automatically reorder supplies 136 of the print media.

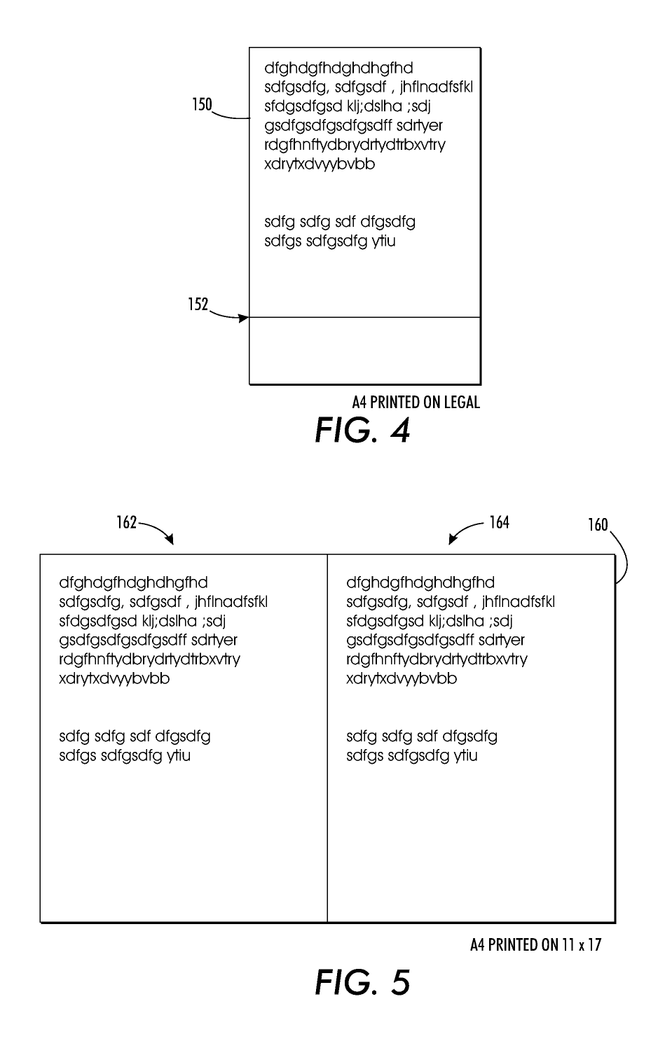

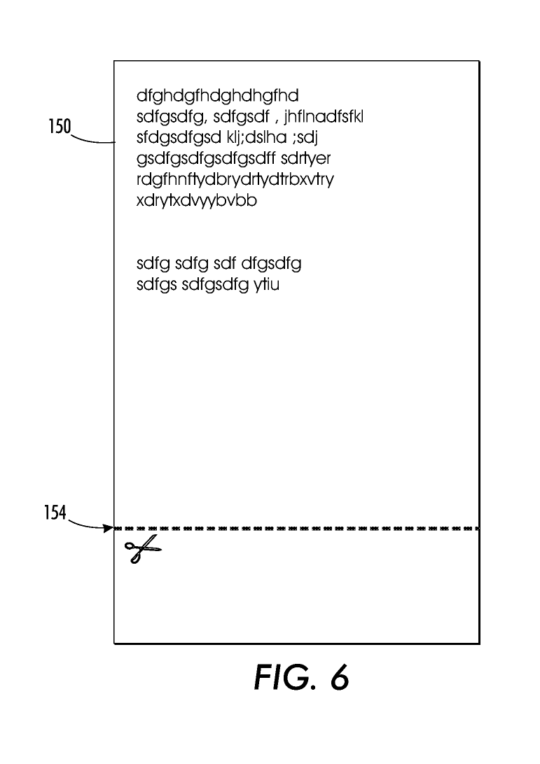

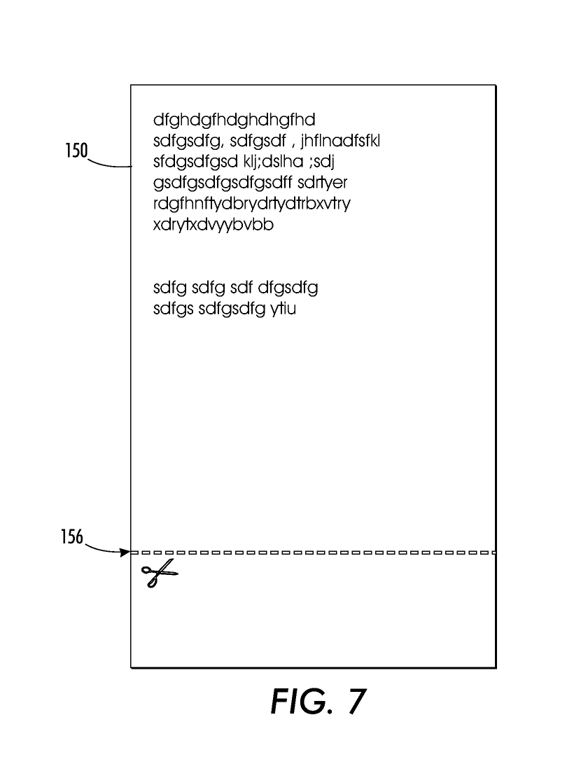

As shown in FIGS. 2 and 3, one of the options 132 can be an option to view the appearance of the printed output of the various options. Examples of the screenshots that display the appearance of the printed output of the various options are shown in FIGS. 4-7. More specifically, FIG. 4 is a graphic illustration displaying how an A4 size print job printed on legal paper 150 would appear when printed (and illustrates where a solid cutline 152 could be located). Similarly, FIG. 5 is a graphic illustration displaying how two A4 sheets (162, 164) would appear printed on 11×17 size paper 160. FIGS. 6 and 7 again illustrates how an A4 size print job would appear printed on legal paper 150, but also illustrate different cut lines 154 (grey dashed line) and 156 (yellow dashed line). While a limited number of screenshot examples are shown in FIGS. 2-7, those ordinarily skilled in the art would understand that the systems and methods herein can provide many other similar illustrations and that the items shown in the drawings are only a limited number of examples used to illustrate that the embodiments herein simultaneously provide an insufficient-print-media message and options for completing the print job with the installed print media.

Referring back to FIG. 1, in item 108 the user then selects one of the options 132 presented in item 106. In response to the option selection made by the user, the user or technician can load the preferred print media in item 110, causing the computerized device to receive an indication from the selected printing device that the preferred print media has been installed into the selected printing device. Then processing can proceed to item 116, where the original print request is printed on the preferred print media in item 116.

Alternatively, as shown in item 112, rather than loading the preferred media, the user can select a reconfiguration option from the reconfiguration options 132 presented that identifies the alternative print media from the installed print media types to be used in place of the preferred print media when executing the print request. The selected reconfiguration option also identifies additional processing 114 to be performed by the computerized device.

Such additional processing 114 can include, for example, automatically resizing the print data to fit on the alternative print media, automatically printing a cutline on the alternative print media to indicate where the alternative print media should be cut to be reduced to the preferred print media, automatically formatting multiple pages of the print data to print on one page of the alternative print media. When resizing in item 114, the methods herein can increase (or decrease) the print size if the alternative print media is smaller (or larger) than the preferred print media. As shown above, the cutline can be, for example, a dashed-line or a light line such as yellow, gray, etc.

When formatting multiple pages of the print data to print on one page of the alternative print media, the processing in item 114 can perform duplex printing by changing the horizontal/vertical orientation of the pages of the print data, and positioning at least two of the pages of the print data on each side of the one page of the alternative print media. After the above processing, the modified print request is printed on the alternative print media in item 116.

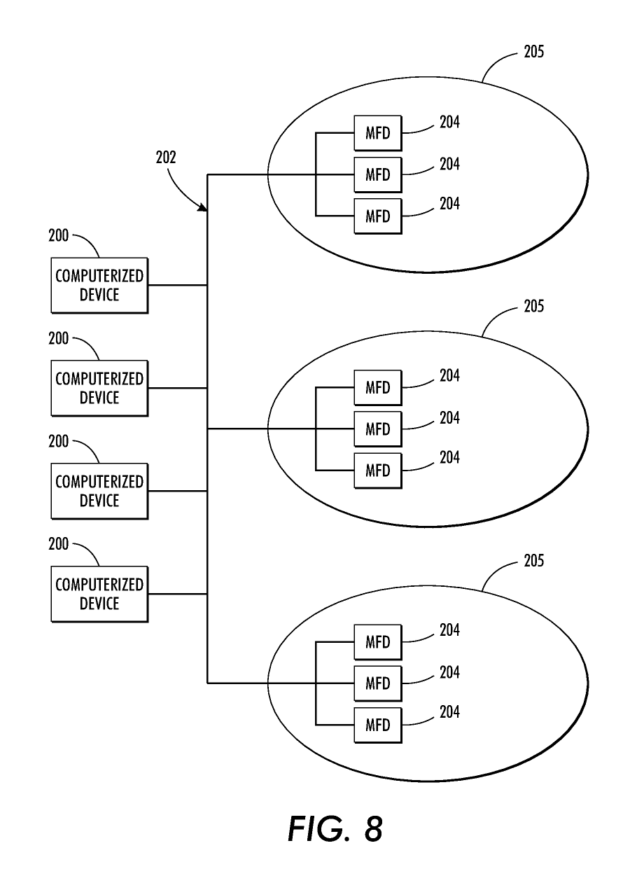

As shown in FIG. 8, exemplary system embodiments herein include various computerized devices 200, 204 located at various different physical locations 205. The computerized devices 200, 204 can include print servers, printing devices, personal computers, etc., and are in communication (operatively connected to one another) by way of a local or wide area (wired or wireless) network 202.

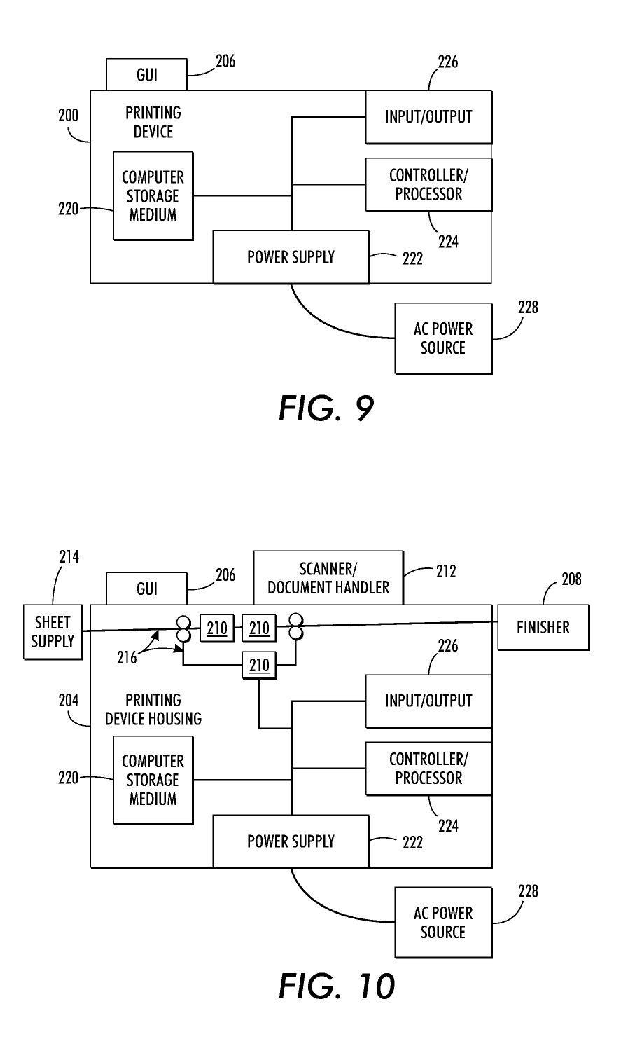

FIG. 9 illustrates a computerized device 200, which can be used with embodiments herein and can comprise, for example, a print server, a personal computer, a portable computing device, etc. The computerized device 200 includes a controller/processor 224 and a communications port (input/output) 226 operatively connected to the processor 224 and to the computerized network 202 external to the computerized device 200. Also, the computerized device 200 can include at least one accessory functional component, such as a graphic user interface assembly 206 that also operate on the power supplied from the external power source 228 (through the power supply 222).

The input/output device 226 is used for communications to and from the computerized device 200. The processor 224 controls the various actions of the computerized device. A non-transitory computer storage medium device 220 (which can be optical, magnetic, capacitor based, etc.) is readable by the processor 224 and stores instructions that the processor 224 executes to allow the computerized device to perform its various functions, such as those described herein. Thus, as shown in FIG. 9, a body housing 200 has one or more functional components that operate on power supplied from the alternating current (AC) 228 by the power supply 222. The power supply 222 can comprise a power storage element (e.g., a battery) and connects to an external alternating current power source 228 and converts the external power into the type of power needed by the various components.

FIG. 10 illustrates a computerized device that is a printing device 204, which can be used with embodiments herein and can comprise, for example, a printer, copier, multi-function machine, multi-function device (MFD), etc. The printing device 204 includes many of the components mentioned above and at least one marking device (printing engines) 210 operatively connected to the processor 224, a media path 216 positioned to supply sheets of media from a sheet supply 214 to the marking device(s) 210, etc. After receiving various markings from the printing engine(s), the sheets of media can optionally pass to a finisher 208 which can cut, fold, staple, sort, etc., the various printed sheets. Also, the printing device 204 can include at least one accessory functional component (such as a scanner/document handler 212, etc.) that also operate on the power supplied from the external power source 228 (through the power supply 222).

In one example, the finisher 208 can automatically cut the larger sheets at the location of the cutline 152 illustrated above (or can, for example automatically cut the 11×17 sheet illustrated in FIG. 5 to separate the different printed pages) without having to print the cutline 152. Instead of printing the cutline 152, the processor controls the finisher 208 to perform the cut where the cutline 152 would have been printed. Using such a finisher 208 further enhances user satisfaction by avoiding the work and time needed to manually cut the alternative print media along the cutline 152.

Many computerized devices are discussed above. Computerized devices that include chip-based central processing units (CPU's), input/output devices (including graphic user interfaces (GUI), memories, comparators, processors, etc. are well-known and readily available devices produced by manufacturers such as Dell Computers, Round Rock Tex., USA and Apple Computer Co., Cupertino Calif., USA. Such computerized devices commonly include input/output devices, power supplies, processors, electronic storage memories, wiring, etc., the details of which are omitted herefrom to allow the reader to focus on the salient aspects of the embodiments described herein. Similarly, scanners, finishers, and other similar peripheral equipment are available from Xerox Corporation, Norwalk, Conn., USA and the details of such devices are not discussed herein for purposes of brevity and reader focus.

The terms printer or printing device as used herein encompasses any apparatus, such as a digital copier, bookmaking machine, facsimile machine, multi-function machine, etc., which performs a print outputting function for any purpose. The details of printers, printing engines, scanners, finishers etc., are well-known by those ordinarily skilled in the art and are discussed in, for example, U.S. Pat. No. 6,032,004, the complete disclosure of which is fully incorporated herein by reference. The embodiments herein can encompass embodiments that print in color, monochrome, or handle color or monochrome image data. All foregoing embodiments are specifically applicable to electrostatographic and/or xerographic machines and/or processes.

In addition, terms such as “right”, “left”, “vertical”, “horizontal”, “top”, “bottom”, “upper”, “lower”, “under”, “below”, “underlying”, “over”, “overlying”, “parallel”, “perpendicular”, etc., used herein are understood to be relative locations as they are oriented and illustrated in the drawings (unless otherwise indicated). Terms such as “touching”, “on”, “in direct contact”, “abutting”, “directly adjacent to”, etc., mean that at least one element physically contacts another element (without other elements separating the described elements). Further, the terms automated or automatically mean that once a process is started (by a machine or a user), one or more machines perform the process without further input from any user.

It will be appreciated that the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims. Unless specifically defined in a specific claim itself, steps or components of the embodiments herein cannot be implied or imported from any above example as limitations to any particular order, number, position, size, shape, angle, color, or material.

What is claimed is:

1. A method comprising:
receiving a print request into a computerized device from a user, said print request including print data, and said print request identifying a required quantity of preferred print media and at least one selected printing device;
automatically determining quantities of one or more installed print media types currently installed in said selected printing device, using said computerized device;
when said quantities of said installed print media types indicate an insufficient quantity of said preferred print media is installed in said selected printing device, automatically outputting from said computerized device to said user an insufficient-print-media notice and one or more reconfiguration options for proceeding with printing said print data on one of said installed print media types;
receiving into said computerized device from said user a selected reconfiguration option from said reconfiguration options, said selected reconfiguration option identifying an alternative print media from said installed print media types to be used in place of said preferred print media when executing said print request, said selected reconfiguration option identifying additional processing to be performed by said computerized device; and
in response to said receiving of said selected reconfiguration option, said computerized device performing said additional processing to print said print data on said alternative print media,
said additional processing comprising at least one of:
automatically resizing said print data to fit on said alternative print media;
automatically printing a cutline on said alternative print media to indicate where said alternative print media should be cut to be reduced to said preferred print media; and
automatically formatting multiple pages of said print data to print on one page of said alternative print media.

2. The method according to claim 1, said resizing comprising one of:
increasing a print size if said alternative print media is larger than said preferred print media; and
decreasing a print size if said alternative print media is smaller than said preferred print media.

3. The method according to claim 1, said cutline comprising at least one of a dashed-line and a line comprising at least one of: yellow; and gray.

4. The method according to claim 1, said formatting multiple pages of said print data to print on one page of said alternative print media comprising duplex printing and comprising:
changing a horizontal/vertical orientation of said pages of said print data; and
positioning at least two of said pages of said print data on each side of said one page of said alternative print media.

5. The method according to claim 1, said outputting of said reconfiguration options comprising:
displaying a dialog containing said reconfiguration options; and
displaying a graphic representation of a print appearance of each of said reconfiguration options.

6. A method comprising:
receiving a print request into a computerized device from a user, said print request including print data, and said print request identifying a required quantity of preferred print media and at least one selected printing device;
automatically determining quantities of one or more installed print media types currently installed in said selected printing device, using said computerized device;
when said quantities of said installed print media types indicate an insufficient quantity of said preferred print media is installed in said selected printing device, automatically simultaneously outputting from said computerized device to said user an insufficient-print-media notice and one or more reconfiguration options for proceeding with printing said print data on one of said installed print media types;
receiving into said computerized device one of:
an indication from said selected printing device that said print media of said preferred print media has been installed into said selected printing device; and
an indication from said user of a selected reconfiguration option from said reconfiguration options, said selected reconfiguration option identifying an alternative print media from said installed print media types to be used in place of said preferred print media when executing said print request, said selected reconfiguration option identifying additional processing to be performed by said computerized device; and
in response to said receiving of said selected reconfiguration option, said computerized device performing said additional processing to print said print data on said alternative print media,
said additional processing comprising at least one of:
automatically resizing said print data to fit on said alternative print media;
automatically printing a cutline on said alternative print media to indicate where said alternative print media should be cut to be reduced to said preferred print media; and
automatically formatting multiple pages of said print data to print on one page of said alternative print media.

7. The method according to claim 6, said resizing comprising one of:
increasing a print size if said alternative print media is larger than said preferred print media; and
decreasing a print size if said alternative print media is smaller than said preferred print media.

8. The method according to claim 6, said cutline comprising at least one of a dashed-line and a line comprising at least one of: yellow; and gray.

9. The method according to claim 6, said formatting multiple pages of said print data to print on one page of said alternative print media comprising duplex printing and comprising:
changing a horizontal/vertical orientation of said pages of said print data; and
positioning at least two of said pages of said print data on each side of said one page of said alternative print media.

10. The method according to claim 6, said outputting of said reconfiguration options comprising:
displaying a dialog containing said reconfiguration options; and
displaying a graphic representation of a print appearance of each of said reconfiguration options.

11. A system comprising:
a computerized device receiving a print request from a user;
a printing device operatively connected to said computerized device,
said print request including print data,
said print request identifying a required quantity of preferred print media,
said printing device automatically determining quantities of one or more installed print media types currently installed in said printing device,
when said quantities of said installed print media types indicate an insufficient quantity of said preferred print media is installed in said selected printing device, said computerized device automatically outputting to said user an insufficient-print-media notice and one or more reconfiguration options for proceeding with printing said print data on one of said installed print media types,
said computerized device receiving from said user a selected reconfiguration option from said reconfiguration options,
said selected reconfiguration option identifying an alternative print media from said installed print media types to be used in place of said preferred print media when executing said print request,
said selected reconfiguration option identifying additional processing to be performed by said computerized device,
in response to said receiving of said selected reconfiguration option, said computerized device performing said additional processing to print said print data on said alternative print media, and
said additional processing comprising at least one of:
automatically resizing said print data to fit on said alternative print media;
automatically printing a cutline on said alternative print media to indicate where said alternative print media should be cut to be reduced to said preferred print media; and
automatically formatting multiple pages of said print data to print on one page of said alternative print media.

12. The system according to claim 11, said resizing comprising one of:
increasing a print size if said alternative print media is larger than said preferred print media; and
decreasing a print size if said alternative print media is smaller than said preferred print media.

13. The system according to claim 11, said cutline comprising at least one of a dashed-line and a line comprising at least one of: yellow; and gray.

14. The system according to claim 11, said formatting multiple pages of said print data to print on one page of said alternative print media comprising duplex printing and comprising:
changing a horizontal/vertical orientation of said pages of said print data; and
positioning at least two of said pages of said print data on each side of said one page of said alternative print media.

15. The system according to claim 11, said outputting of said reconfiguration options comprising:
displaying a dialog containing said reconfiguration options; and
displaying a graphic representation of a print appearance of each of said reconfiguration options.

16. A non-transitory computer storage medium readable by a computerized device, said non-transitory computer storage medium storing instructions executable by said computerized device to perform a method comprising:
receiving a print request from a user, said print request including print data, and said print request identifying a required quantity of preferred print media and at least one selected printing device;
automatically determining quantities of one or more installed print media types currently installed in said selected printing device;
when said quantities of said installed print media types indicate an insufficient quantity of said preferred print media is installed in said selected printing device, automatically outputting to said user an insufficient-print-media notice and one or more reconfiguration options for proceeding with printing said print data on one of said installed print media types;
receiving from said user a selected reconfiguration option from said reconfiguration options, said selected reconfiguration option identifying an alternative print media from said installed print media types to be used in place of said preferred print media when executing said print request, said selected reconfiguration option identifying additional processing to be performed; and
in response to said receiving of said selected reconfiguration option, performing said additional processing to print said print data on said alternative print media,
said additional processing comprising at least one of:
automatically resizing said print data to fit on said alternative print media;
automatically printing a cutline on said alternative print media to indicate where said alternative print media should be cut to be reduced to said preferred print media; and
automatically formatting multiple pages of said print data to print on one page of said alternative print media.

17. The non-transitory computer storage medium according to claim 16, said resizing comprising one of:
increasing a print size if said alternative print media is larger than said preferred print media; and
decreasing a print size if said alternative print media is smaller than said preferred print media.

18. The non-transitory computer storage medium according to claim 16, said cutline comprising at least one of a dashed-line and a line comprising at least one of: yellow; and
gray.

19. The non-transitory computer storage medium according to claim 16, said formatting multiple pages of said print data to print on one page of said alternative print media comprising duplex printing and comprising:
changing a horizontal/vertical orientation of said pages of said print data; and
positioning at least two of said pages of said print data on each side of said one page of said alternative print media.

20. The non-transitory computer storage medium according to claim 16, said outputting of said reconfiguration options comprising:
displaying a dialog containing said reconfiguration options; and
displaying a graphic representation of a print appearance of each of said reconfiguration options.
